(19) United States
(12) Patent Application Publication
(10) Pub. No.: US 2016/0257060 A1
(43) Pub. Date: Sep. 8, 2016

(54) IMPRINT APPARATUS, IMPRINT METHOD, AND ARTICLE MANUFACTURING METHOD

(71) Applicant: CANON KABUSHIKI KAISHA, Tokyo (JP)

(72) Inventors: Hirohito Ito, Funabashi-shi (JP); Tosiya Asano, Utsunomiya-shi (JP)

(21) Appl. No.: 15/049,649

(22) Filed: Feb. 22, 2016

(30) Foreign Application Priority Data
Mar. 3, 2015 (JP) 2015-041491

(51) Int. Cl. B29C 59/00; B29C 59/02

(52) U.S. Cl. CPC B29C 59/002; B29C 59/02

(57) ABSTRACT

Provided is an imprint apparatus that brings a mold into contact with an imprint material on a substrate to perform patterning on the substrate, and includes a mold holder configured to hold the mold; a substrate holder configured to hold the substrate; a driving device configured to move at least one of the mold holder and the substrate holder; a detector configured to detect a state of the driving device; and a controller configured to perform decision that release of the mold is started based on an output of the detector and to control the driving device so as to decrease a force for the release by the driving device in accordance with the decision.

### BACKGROUND OF THE INVENTION

1. Field of the Invention

The present invention relates to an imprint apparatus, an imprint method, and an article manufacturing method.

2. Description of the Related Art

There is a microfabrication technology that forms a pattern on a substrate by imprint processing for molding an imprint material on the substrate with use of a mold. This technology is also referred to as an “imprint technology”, by which a pattern (structure) with dimensions of a few nanometers can be formed on a substrate. One example of imprint technologies includes a photo-imprint method. An imprint apparatus employing the photo-imprint method first supplies a photo-curable material (resin) to a shot area on a substrate. Next, the imprint material on the substrate is molded with use of a mold. After the imprint material is irradiated with light for curing, the cured imprint material is released from the mold, whereby a pattern is formed on the substrate. Imprint technologies include not only the photo-imprint method but also the thermal imprint method with use of a thermoplastic material (resin) or the like.

In regard to the improvement in throughput of the imprint apparatus, an increase in speed in mold-releasing is also effective. Japanese Patent Laid-Open No. 2007-81048 discloses an imprint apparatus that detects the timing at which the mold releasing is started with use of an optical sensor, temporarily stops the mold-releasing operation once the mold-releasing is started to wait for the sufficient progress of the mold-releasing, and then completes the mold-releasing at a high speed. In this manner, both the decrease in occurrence of a pattern defect and a greater throughput can be achieved.

Here, the timing at which the mold-releasing is started and the magnitude of the mold-releasing force to be applied at that time exhibit poor reproducibility and are highly likely to vary from time to time. Thus, if an attempt is made by the technology as disclosed in Japanese Patent Laid-Open No. 2007-81048 to reduce such variation by the temporal stop of the mold-releasing operation before and after the start of mold-releasing, there is a limitation in improvement in throughput. On the other hand, it is also contemplated that a greater mold-releasing force is applied for a short time to achieve greater throughput, which however results in further reduction in reproducibility. The mold-releasing force and the reaction force are balanced from the start of applying the mold-releasing force to the start of mold-releasing, so that both the substrate stage and the mold holding mechanism are substantially stationary. Once the mold-releasing is started, the reaction force is rapidly decreased. Thus, an abrupt change may occur at the position of the substrate stage. The mold-releasing force may reach to, for example, about 100 N. Hence, if the mold-releasing force is not quickly decreased with a decrease in the reaction force, the mold-releasing force that is greater than necessary is applied to a pattern or a mold, resulting in the occurrence of a defect therein.

### SUMMARY OF THE INVENTION

The present invention provides, for example, an imprint apparatus which is advantageous in terms of compatibility between accurate patterning and throughput.

According to an aspect of the present invention, an imprint apparatus that brings a mold into contact with an imprint material on a substrate to perform patterning is provided that includes a mold holder configured to hold the mold; a substrate holder configured to hold the substrate; a driving device configured to move at least one of the mold holder and the substrate holder; a detector configured to detect a state of the driving device; and a controller configured to perform decision that release of the mold is started based on an output of the detector and to control the driving device so as to decrease a force for the release by the driving device in accordance with the decision.

Further features of the present invention will become apparent from the following description of exemplary embodiments with reference to the attached drawings.

### BRIEF DESCRIPTION OF THE DRAWINGS

FIG. 1 is a diagram illustrating a configuration of an imprint apparatus according to a first embodiment of the present invention.

FIG. 2 is a block diagram illustrating a control system for a fine movement stage according to the first embodiment.

FIG. 3 is a block diagram illustrating a force command generating unit according to the first embodiment.

FIG. 4 is a graph illustrating changes in a force detection value and a command value according to the first embodiment.

FIG. 5 is a diagram illustrating a configuration of an imprint apparatus according to a third embodiment of the present invention.

FIG. 6 is a block diagram illustrating a control system for a mold driving mechanism according to the third embodiment.

FIG. 7 is a graph illustrating changes in a force detection value and a command value according to a Comparative Example.

### DESCRIPTION OF THE EMBODIMENTS

Hereinafter, a description will be given of a vibration type actuator according to an embodiment of the present invention with reference to the drawings.

### First Embodiment

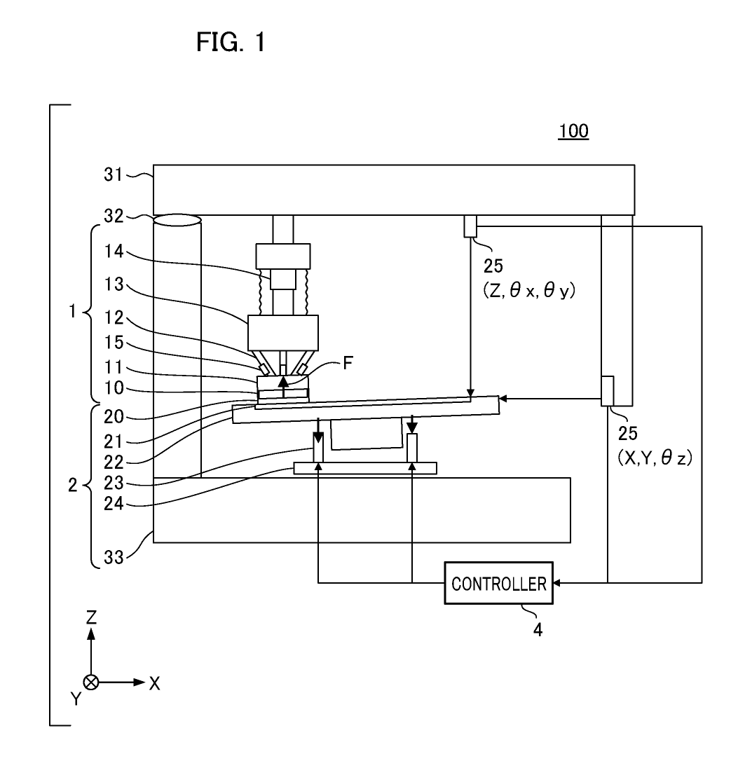

First, a description will be given of an imprint apparatus according to a first embodiment of the present invention. FIG. 1 is a schematic view illustrating a configuration of an imprint apparatus 100 according to the present embodiment. The imprint apparatus 100 is used to manufacture a semiconductor device, etc. as an article, brings an uncured resin (imprint material) 20 coated on a substrate 21 into contact with a mold 10, and forms a pattern to the resin 20 on the substrate 21. Note that the imprint apparatus 100 is intended to employ a photo-imprint method as an example. In the following drawings, a description will be given where the Z axis is aligned in the up and down direction (vertical direction) and mutually orthogonal axes X and Y are aligned in a plane perpendicular to the Z axis. The imprint apparatus 100 includes an illumination system (not shown), a mold holding mechanism (mold holder) 1, a substrate stage (substrate holder) 2, a dispenser (not shown), and a controller 4.

The illumination system is a resin curing unit that irradiates the mold 10 with ultraviolet light emitted from a light source by adjusting the ultraviolet light to light suitable for curing the resin 20. The light source may be any light source as long as it emits not only ultraviolet light but also light having a wavelength that transmits through the mold 10 and cures the resin 20. For example, when a thermal-curing method is employed, a heating unit for curing a thermosetting resin is disposed instead of the illumination system as a resin curing unit in the vicinity of the substrate stage 2.

The mold 10 is a mold that has a rectangular planar shape and has a concave-convex pattern, such as a three-dimensionally formed circuit pattern or the like, formed at the central portion of the surface opposite to the substrate 21. As the material of the mold 10, any ultraviolet light transmissive material such as quartz may be employed.

The mold holding mechanism (mold holder) 1 has a mold chuck 11 for holding the mold 10, a mold driving mechanism (driving device) 14 for supporting and moving the mold chuck 11, and a flexure 12. The mold chuck 11 holds the mold 10 by suctioning or attracting the outer peripheral area of the surface of the mold 10 to be irradiated with ultraviolet light using a vacuum suction force or an electrostatic force. Also, each of the mold chuck 11 and the mold driving mechanism 14 has an aperture area at the central portion (the inside thereof) such that ultraviolet light emitted from the illumination system is directed toward the substrate 21 by passing through the mold 10. The mold driving mechanism 14 moves the mold 10 when the mold 10 is roughly aligned with the substrate 21 in the Z-axial direction at the time of bringing them into contact with each other or retracts the mold 10 during the attaching/detaching operations of the mold 10 or at an abnormal time. The flexure 12 is warped when the load is applied on the mold 10 by bringing the mold 10 into contact with the substrate 21 so as to conform the mold 10 to the surface of the substrate 21. The mold chuck 11 is connected to a supporting table 13 via the flexure 12. The supporting table 13 is connected to a main body 31 via the mold driving mechanism 14. The main body 31 is mounted on a surface plate 33 via a mount 32 for vibration insulation.

The mold holding mechanism 1 further generates a force (load, physical quantity) to be applied to the mold 10 i.e., a mold-releasing force and has a force sensor (detector) 15 that, detects a quantity (state) relating to the driving of a fine movement stage 22 for receiving a reaction force. In other words, the state refers to a force acting on at least one of the mold holding mechanism 1 and the substrate stage 2. As the force sensor 15, a load cell, a strain gauge, a piezoelectric element, or the like may be employed. For example, when a strain gauge is employed as the force sensor 15, the strain gauge is attached to the flexure 12 to detect a bending of the flexure 12. Here, in order for the force sensor 15 to detect a force to be applied to the mold 10 upon releasing the mold 10 from the resin 20 on the substrate 21, the force sensor 15 needs to be configured such that it can detect a force in the Z-axial direction (releasing direction). At least six force sensors 15 need to be arranged for detecting a force in six axial directions as a whole.

The substrate 21 is a wafer consisting of, for example, single crystal silicon. For use in the manufacture of articles other than semiconductor devices, as the material of the substrate 21, an optical glass such as quartz may be employed for an optical element and GaN, SiC or the like may be employed for a light-emitting element.

The substrate stage (substrate holder) 2 is movable while holding the substrate 21. The substrate stage 2 aligns the mold 10 with the substrate 21 and moves the substrate 21 in the Z-axial direction so as to selectively bring the mold 10 into contact with the resin 20 on the substrate 21 or release the mold 10 from the resin 20. The substrate stage 2 includes a fine movement stage 22 and a coarse movement stage 24. The fine movement stage 22 includes a top plate on which the substrate 21 is placed and at least six linear motors (driving devices) 23 capable of performing positioning in six degrees of freedom. Note that an electromagnet or the like may also be used instead of a linear motor. The fine movement stage 22 is supported in a non-contact by the driving force of the linear motor 23, and thus, can be positioned with high accuracy. The position of the fine movement stage 22 is detected with use of a laser interferometer (detector) 25 on the main body 31. As the position detector, an encoder or the like may also be used instead of the laser interferometer 25. The controller 4 can also determine a relative displacement between the fine movement stage 22 and the mold 10 by simultaneously causing the laser interferometer 25 to detect the position of the mold 10 or the mold chuck 11 and taking a difference between the position of the mold 10 or the mold chuck 11 and the position detection value of the fine movement stage 22. In this manner, even if the position of the mold 10 varies, the fine movement stage 22 can be accurately aligned with the mold 10. On the other hand, the coarse movement stage 24 mounts the fine movement stage 22 in a non-contact via the linear motor 23, and can move a multiphase type linear motor (actuator) (not shown) capable of long-distance driving in the X-Y axial directions which are the combination of the X- and Y-axial directions. As the actuator, a plane motor which is movable in the X- and Y-axial directions may be used instead of a multiphase type linear motor. The coarse movement stage 24 can move the transfer position, at which the concave-convex pattern is to be transferred onto the substrate 21, directly below the mold 10.

The dispenser applies the uncured resin 20 to a shot area (pattern forming area) preset on the substrate 21 with a desired application pattern. The resin 20 serving as the imprint material needs to have fluidity when it is filled between the mold 10 and the substrate 21 but to be solid for retaining its shape after being molded. In particular, in the present embodiment, the resin 20 is an ultraviolet light curable resin (photocurable resin) that exhibits curing properties to such a degree that when exposed to ultraviolet light, but a thermosetting resin, a thermoplastic resin, or the like may also be employed instead of a photocurable resin depending on various conditions such as article manufacturing processes.

The controller 4 is constituted by, for example, a computer or the like and is connected to the components of the imprint apparatus 100 through a line so as to control the operations and adjustment of the components by a program or the like. In particular, in the present embodiment, the controller 4 may execute control in the mold-releasing step as shown in the following. Note that the controller 4 may be integrated with the rest of the imprint apparatus 100 (provided in a shared housing) or may be provided separately from the rest of the imprint apparatus 100 (provided in a separate housing).

Next, a description will be given of the basic flow of imprint processing (imprint method) performed by the imprint apparatus 100. First, the controller 4 causes the dispenser to apply the resin 20 to a predetermined shot area on the substrate 21, and then places the substrate 21 on the substrate stage 2 so as to position the transfer position for each shot area, at which the concave-convex pattern is to be transferred onto the substrate 21, directly below the mold 10 (positioning step). Next, the controller 4 drives at least one of the linear motor 23 and the mold driving mechanism 14 to move at least one of the mold holding mechanism (mold holder) 1 and the substrate stage (substrate holder) 2. In this manner, the substrate 21 and the mold 10 can be approximated to a predetermined interval (e.g., a few nm to 100 nm) (contacting step). Then, the resin 20 on the substrate 21 is filled into the mold 10 in accordance with the concave-convex pattern shape thereof. At this time, the controller 4 needs to control the posture of the substrate stage 2 so as to make an interval between the substrate 21 and the mold 10 uniform. Next, the controller 4 causes the illumination system to illuminate ultraviolet light on the resin 20 to cure (curing step). Then, as in the contacting step, the controller 4 moves at least one of the mold holding mechanism (mold holder) 1 and the substrate stage (substrate holder) 2 and stretches an interval between the substrate 21 and the mold 10 to release the mold 10 from the cured resin 20 (mold-releasing step).

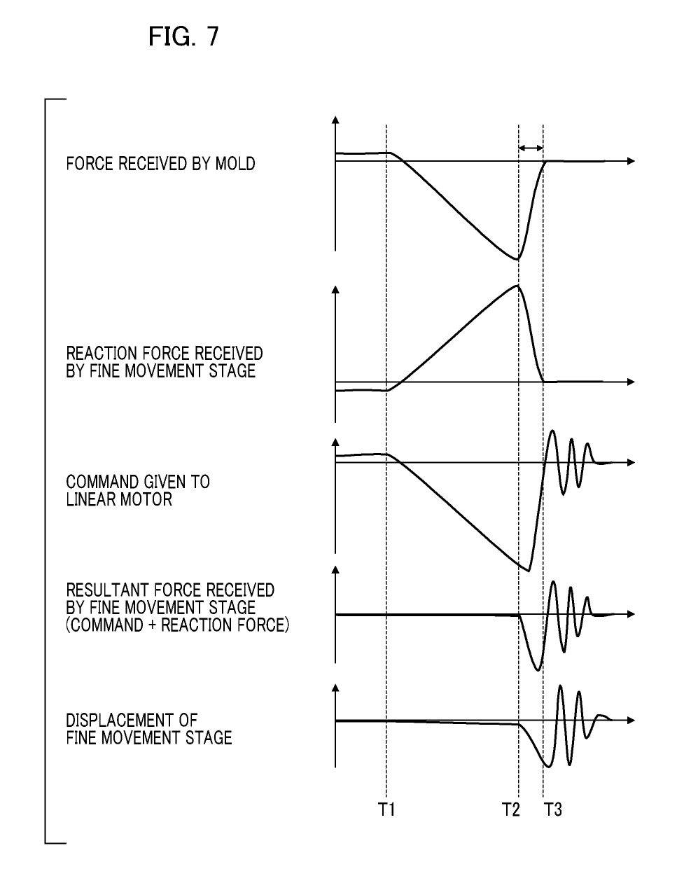

Next, a description will be given of control in the mold-releasing step in the present embodiment. First, as a Comparative Example, a description will be given of the relationship of forces applied to the components in the mold-releasing step when the present invention is not applied. FIG. 7 is a graph illustrating changes in a force detection value and a command value in the Z-axial direction in the mold-releasing step in a Comparative Example, where a time is plotted on the horizontal axis. In the stage of the curing step, the mold driving mechanism 14 is driven to generate an imprint force for pressing the mold 10 toward the negative side in the Z-axial direction. The reason for this is to promote the resin 20 to be filled in the concave-convex pattern of the mold 10. At this time, the fine movement stage 22 receives a force directed toward the negative side in the Z-axial direction and the linear motor 23 generates a force directed toward the positive side in the Z-axial direction for overcoming the negative side force. When the process shifts to the mold-releasing step (T1) after completion of the curing step, the mold driving mechanism 14 is driven to generate a mold-releasing force for peeling the mold 10 toward the positive side in the Z-axial direction. At this time, the fine movement stage 22 receives a force directed toward the positive side in the Z-axial direction and the linear motor 23 generates a force directed toward the negative side in the Z-axial direction for overcoming the positive side force. The mold-releasing force needs to be appropriately generated at the transfer position on the substrate 21. When the transfer position particularly changes, the positional relationship between the linear motor 23 and the transfer position changes, and thus, the controller 4 changes the distribution ratio between forces generated by the individual linear motors 23 depending on the transfer position. The mold 10 receives the force generated by the linear motor 23 via the resin 20, but the force received by the mold 10 is supported by the mechanism of the components constituting the mold holding mechanism 1 and the driving force of the mold driving mechanism 14, so that the position of the mold 10 is maintained. On the other hand, the fine movement stage 22 receives a reaction force from the mold holding mechanism 1 via the resin 20, but the force generated by the linear motor 23 and the reaction force are balanced, so that the position of the fine movement stage 22 is also maintained. Next, if the force generated by the linear motor 23 exceeds a bonding force between the resin 20 and the mold 10, the resin 20 and the mold 10 are peeled off therefore the mold-releasing is started (T2). The reaction force generated via the resin 20 rapidly decreases upon start of the mold-releasing, but the reaction force becomes zero upon completion of the mold-releasing (T3).

However, the reproducibility of the timing of start of the mold-releasing (T2) may not be obtained or feedback control may fail to meet the timing of start of the mold-releasing as shown in the command value to be given to the linear motor 23 in FIG. 7. In this case, the mold-releasing force may be continuously applied in spite of the fact that the mold-releasing force actually becomes unnecessary after completion in the mold-releasing or the displacement of the fine movement stage 22 may remain, which may result in damaging the concave-convex pattern formed on the mold 10. Thus, in the present embodiment, the controller 4 executes the following control in the mold-releasing step.

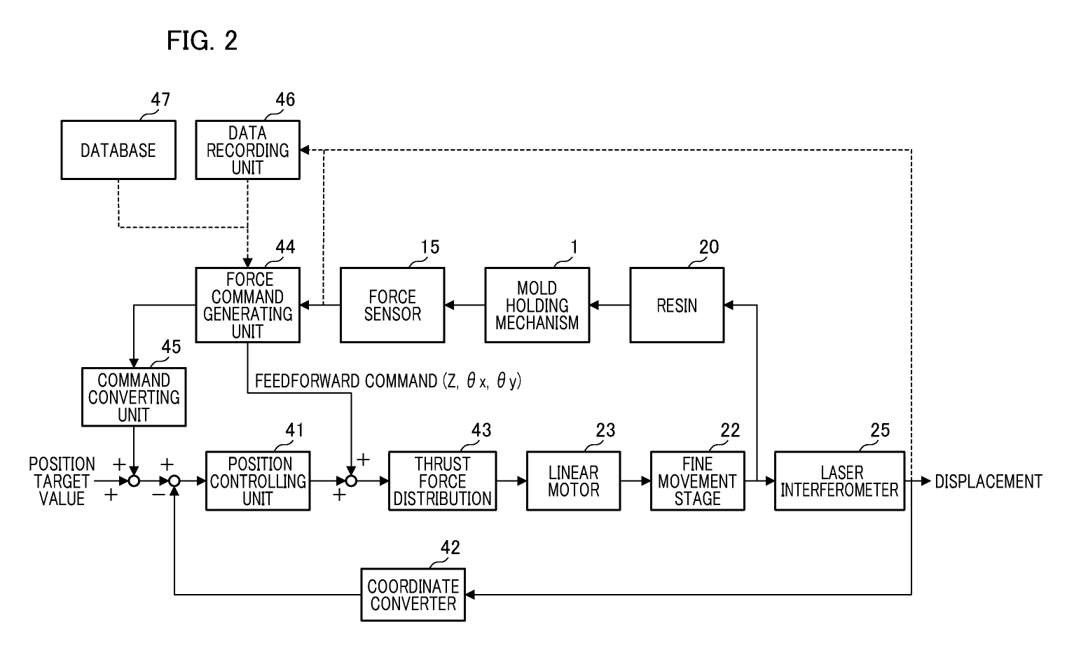

FIG. 2 is a block diagram illustrating an exemplary control system relating to the fine movement stage 22 in the controller 4 in the present embodiment. A position detection value output from the laser interferometer 25 is converted into an orthogonal coordinate system of X, Y, θz, Z, θx, and θy by a coordinate converter 42. A position controller (position controlling unit) 41 includes a PID controller, a filtering unit, a limiting unit, and the like and generates a command value for each axis based on a difference between a position target value and a position detection value. Each command value is converted by the thrust force distribution 43 into a command value for each linear motor 23 and then is output to each linear motor 23 to drive the fine movement stage 22. A force command generating unit 44 generates a force command required for mold-releasing. A command converting unit 45 converts a force command into a corresponding position target value. Note that the control system illustrated in FIG. 2 is a position control system but may also be switched to a force control system in the curing step and the mold-releasing step.

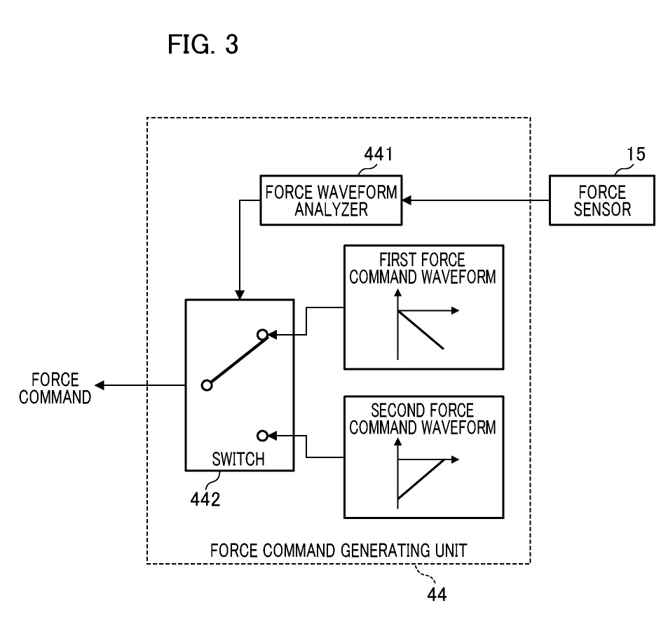

FIG. 3 is a block diagram illustrating an exemplary configuration of a force command generating unit 44. The force command generating unit 44 holds a first force command waveform (first waveform) and a second force command waveform (second waveform), and outputs a force command (command value) based on any one of the force command waveforms. Here, both the first force command waveform and the second force command waveform have a shape to cancel out (reduce) a reaction force received by the fine movement stage 22. Among them, the first force command waveform is a waveform that increases the absolute value of the force directed toward the mold-releasing direction with time. Note that the first force command waveform may be a waveform that partially decreases the absolute value as long as it increases as a whole. On the other hand, the second force command waveform is a waveform that decreases the absolute value of the force directed toward the mold-releasing direction with time. Note that the second force command waveform may be a waveform that partially increases the absolute value as long as it decreases as a whole. A force waveform analyzer 441 first performs decision of start of the mold-releasing based on a detection value output from the force sensor 15. In this case, the detection value is a value of a force serving as a physical quantity used for the decision of start of the mold-releasing. The force waveform analyzer 441 selects either one of the first force command waveform or the second force command waveform based on the judged timing of start of the mold-releasing and causes a switch 442 to switch to the selected force command waveform.

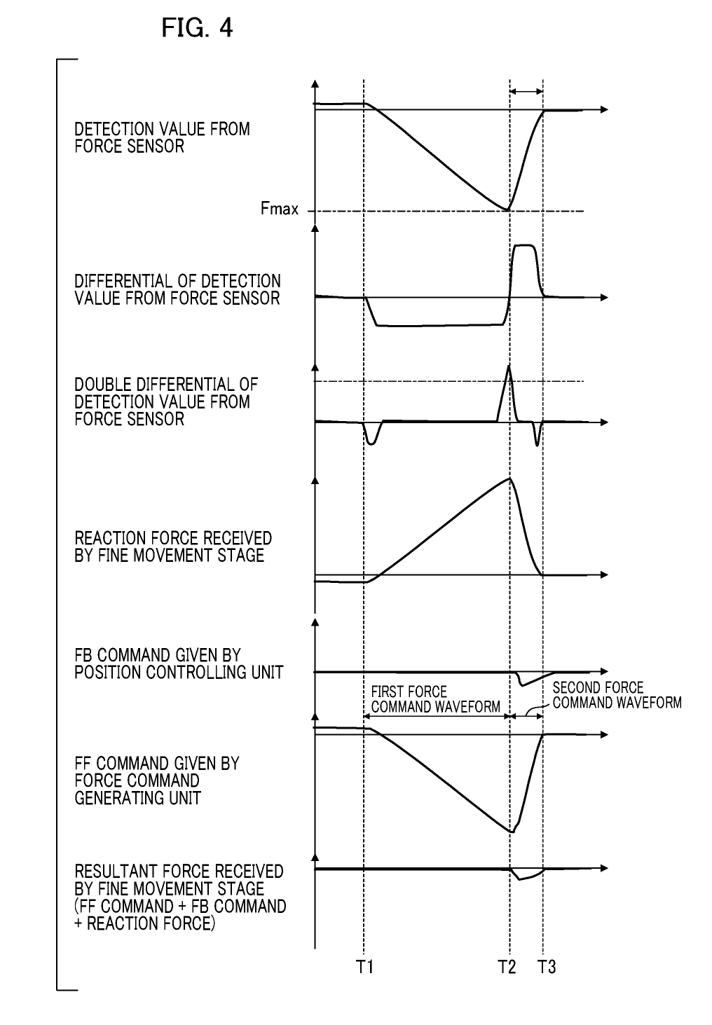

Here, when the linear motor 23 applies the mold-releasing force, the force sensor 15 detects a force pulled downward by a reaction force transferred to the mold holding mechanism 1 via the resin 20. Upon start of the mold-releasing, the force to be detected rapidly decreases due to the absence of the reaction force, so that the force waveform analyzer 441 may perform decision of start of the mold-releasing from a temporal change of the force. More specifically, the following judging methods are contemplated. First, as the first method, the force waveform analyzer 441 may judge the timing at which the shape of the waveform of the detection value obtained by the force sensor 15 is similar to the pre-detected shape before and after start of the mold-releasing as the timing of start of the mold-releasing. Next, as the second method, the force waveform analyzer 441 may judge the timing at which the absolute value of the detection value obtained by the force sensor 15 does not exceed its maximum value, i.e., the absolute value of the detection value changes from increase to decrease as the timing of start of the mold-releasing. Next, as the third method, the force waveform analyzer 441 may judge the timing at which the sign of the determined differentiated value (corresponding to speed) of the detection value obtained by the force sensor 15 changes (reverses) as the timing of start of the mold-releasing. As the fourth method, the force waveform analyzer 441 may judge the timing at which the double differentiated value (corresponding to acceleration) of the detection value obtained by the force sensor 15 exceeds a predetermined set value as the timing of start of the mold-releasing. Note that these specific timings are illustrated in the following FIG. 4. Since a change in the reaction force can be detected from a change in the command value given to the linear motor 23, the command value given to the linear motor 23 may also be used for the decision of the timing of start of the mold-releasing, but the command given to the linear motor 23 changes behind a change in the reaction force. Thus, it is desirable that the detection value obtained by the force sensor 15 be used for the decision of the timing of start of the mold-releasing as described above.

Note that the force waveform analyzer 441 may also judge the timing of start of the mold-releasing using a plurality of judging methods instead of any one of the above judging methods. Also, the force waveform analyzer 441 sets the judging condition of the timing of start of the mold-releasing and the shape of each force command waveform in advance based on a predicted value for a required maximum mold-releasing force (Fₘₐₓ), a mold-releasing time (T3-T2), a delay time in detecting the timing of start of the mold-releasing, or delay properties of the position controller 41. In particular, when the force waveform analyzer 441 detects the timing of start of the mold-releasing, a slight delay may occur due to a response delay of the force sensor 15 or a processing time of the control system. Hence, the force waveform analyzer 441 may modify the judging method in advance so as to make the detected timing adjust beforehand by the amount of delay time. It is desirable that the force waveform analyzer 441 change the maximum value of the second force command waveform as appropriate depending on the maximum mold-releasing force detected by the force sensor 15. It is desirable that the absolute value of the second force command waveform be slightly greater than the reaction force received from the mold 10 to promote the mold-releasing. However, if the absolute value is too greater than the reaction force, variation in the posture of the fine movement stage 22 increases due to the difference therebetween. Hence, the force waveform analyzer 441 may reference the detection value obtained by the force sensor 15 after start of the mold-releasing at any time and change a force waveform so as to maintain the force slightly greater than the detection value. Furthermore, in order to cancel out variation in posture caused by a difference between the reaction force and the force command, the force waveform analyzer 441 may be configured to apply a force in the reverse direction for a shot time immediately after the reaction force becomes substantially zero.

In order to avoid malfunction, the time at which the force sensor 15 starts detection may be limited to the time after elapse of a predetermined time subsequent to the application of the first force command waveform. The force command waveform must cancel out the reaction force at the pattern transfer position on the substrate 21. In particular, when a pattern is transferred to the peripheral portion on the substrate 21, the imbalance of force may occur not only in the Z-axial direction but also in the θx- and θy-directions. Hence, the force waveform analyzer 441 may also be adapted to distribute and output the force command waveforms in the θx- and θy-directions depending on the pattern transfer position.

The controller 4 may also include database 47 that records a predicted value for a required maximum mold-releasing force or a mold-releasing time for each type of resin or each shape of the concave-convex pattern formed on the mold 10. The mold-releasing condition varies depending on the type of resin or the shape of the concave-convex pattern, resulting in a variance in the optimum value of the mold-releasing force. Hence, the database 47 records the relationship between a mold-releasing force and a mold-releasing time which are predetermined for each resin which may be employed or for each concave-convex pattern. In this manner, the force waveform analyzer 441 can select the judging condition of the timing of start of the mold-releasing which is optimum for a resin to be employed or a concave-convex pattern or the shape of the force command waveform with reference to the relationship recorded in the database 47.

Furthermore, the controller 4 may also be adapted to include a data recording unit 46 that records at least any one log data of the position detection value of the substrate stage 2, the amount of operation of each axis, and the detection value obtained by the force sensor 15 in the mold-releasing step. In this manner, the force waveform analyzer 441 can change the judging condition of a more appropriate timing of start of the mold-releasing and the shape of the force command waveform with reference to log data recorded in the data recording unit 46. Furthermore, the judging condition of the optimized timing of start of the mold-releasing and the shape of the force command waveform are recorded in the database 47, so that the force command generating unit 44 can use the optimum value in subsequence.

FIG. 4 is a graph illustrating changes in a force detection value and a command value in the Z-axial direction in the mold-releasing step in the present embodiment, where a time is plotted on the horizontal axis. First, when the controller 4 causes the linear motor 23 to start application of the mold-releasing force (T1), the force waveform analyzer 441 causes the switch 442 to select the first force command waveform required for the mold-releasing to generate and output a force command. As shown in FIG. 2, the generated force command is added to a command generated by the position controller 41 as a feedforward (FF) command, and is input to the command converting unit 45 to be converted into a corresponding position target value. More specifically, the force waveform analyzer 441 gives a position target value slightly downwardly offset with respect to the position controller 41 to thereby generate a relative displacement between the mold 10 and the substrate 21. In this manner, the position controller 41 generates a mold-releasing force as a feedback (FB) command for overcoming the reaction force in order to maintain the position target value. In this case, it should be noted that a position target value needs to be determined by calculating in advance how much reaction force is generated with respect to the amount of displacement from the position target value. Briefly, the controller 4 calculates the displacement of the resin corresponding to a predetermined force command using the rigidity value, i.e., the spring constant of the resin to determine a position target value based on the displacement. Here, if conversion of the first force command waveform into the position target value is appropriate, almost all commands become feedforward commands and only a few feedback commands are generated. Next, when the force waveform analyzer 441 detects the timing of start of the mold-releasing (T2) judged by the judging method as described above, the force waveform analyzer 441 causes the switch 442 to select the second force command waveform to generate and output a force command. The second force command waveform is a waveform for decreasing the mold-releasing force and is added as a feedforward command to a command generated by the position controller 41. Note that the controller 4 may change the position target value of the substrate stage 2 in parallel fashion. For example, the controller 4 may cause the substrate stage 2 to start movement toward the next transfer position by further reducing the Z axis target value to ensure an interval between the mold 10 and the substrate 21 and changing XY-target values. In this manner, the imprint apparatus 100 can perform the mold-releasing step more quickly, resulting in an improvement in throughput. When a force command waveform cannot be appropriately set due to some malfunction, the force command waveform and the reaction force cannot be cancelled out. Consequently, it is also contemplated that the substrate stage 2 is largely displaced, and thus, for example, the fine movement stage 22 rises to collide with the mold 10. Thus, in order to avoid such an operation, the controller 4 may also be adapted to stop to output a force command when the speed of movement of the fine movement stage 22 increases in the course of the mold-releasing.

As described above, the imprint apparatus 100 can suppress application of the mold-releasing force more than necessity in the mold-releasing step, and thus, can suppress a breakage of the concave-convex pattern of the mold 10. In addition, in order to suppress application of the mold-releasing force more than necessity, the imprint apparatus 100 does not temporarily stop the mold-releasing after the mold-releasing starts, resulting in an improvement in throughput. Furthermore, variation in posture of the substrate stage 2 is suppressed even if the mold-releasing force is more rapidly applied thereto, resulting in a reduction in the application time of the mold-releasing force, which also can lead to an improvement in throughput. The configuration of the substrate stage which may be applied in the present embodiment is not limited to include the fine movement stage 22 which is supported in a non-contact by the coarse movement stage 24 and is controlled along six axes by the actuator as long as the force command generating unit 44 or the like is present. It should be noted that the imprint apparatus 100 which employs the substrate stage 2 having such a fine and coarse movement configuration exhibits an excellent floor vibration insulation performance, resulting in achieving highly-accurate positioning. In particular, in a non-contact stage such as the fine movement stage 22, it is contemplated that a breakage due to an impact may occur on the non-contact stage if an excessive mold-releasing force acts, whereas to the present embodiment is also advantageous to be capable of suppressing such a breakage due to an impact.

As described above, according to the present embodiment, an imprint apparatus and an imprint method which are advantageous for improving throughput and suppressing a breakage of the concave-convex pattern formed on the mold may be provided.

### Second Embodiment

Next, a description will be given of an imprint apparatus according to a second embodiment of the present invention. In the above first embodiment, the force sensor 15 serving as a force detector is used as a detector for detecting a physical quantity (the state of the driving device) for judging the timing of start of the mold-releasing. In contrast, a feature of the imprint apparatus according to the present embodiment lies in the fact that the laser interferometer 25 serving as a position detector is employed as the physical quantity detector instead of the force detector in the imprint apparatus 100 according to the first embodiment. In this case, the detection value is a value of the position of the fine movement stage 22(the position of the substrate stage 2) as the physical quantity.

If no reaction force is produced, the force generated by the linear motor 23 cannot be balanced, resulting in variation in the posture of the fine movement stage 22. Thus, the force waveform analyzer 441 may analyze a variation in posture using the position detection value of the fine movement stage 22 detected by the laser interferometer 25 to judge the timing of start of the mold-releasing. More specifically, the following judging methods are contemplated. First, as the first method, the force waveform analyzer 441 may judge the timing at which the Z axis deviation of the fine movement stage 22 exceeds a predetermined value as the timing of start of the mold-releasing. Next, as the second method, the force waveform analyzer 441 may judge the timing which exceeds a predetermined value based on a temporal change in the Z axis speed of the fine movement stage 22 as the timing of start of the mold-releasing. Next, as the third method, the force waveform analyzer 441 may judge the timing which exceeds a predetermined value based on a temporal change in the Z axis acceleration of the fine movement stage 22 as the timing of start of the mold-releasing. Also, in the present embodiment, the force waveform analyzer 441 may judge the timing of start of the mold-releasing using a plurality of judging methods instead of any one of the above judging methods.

According to the present embodiment, the same effect as that in the first embodiment is provided and the laser interferometer has a higher responsibility than that of the force sensor, so that the timing of start of the mold-releasing can be judged quickly.

### Third Embodiment

Next, a description will be given of an imprint apparatus according to a third embodiment of the present invention. In the above embodiments, the force command generating unit 44 is provided in the control system for the substrate stage 2 (the fine movement stage 22). In contrast, a feature of an imprint apparatus 200 according to the present embodiment lies in the fact that the same force command generating unit 44 is provided in the control system for the mold driving mechanism 14 included in the mold holding mechanism 1.

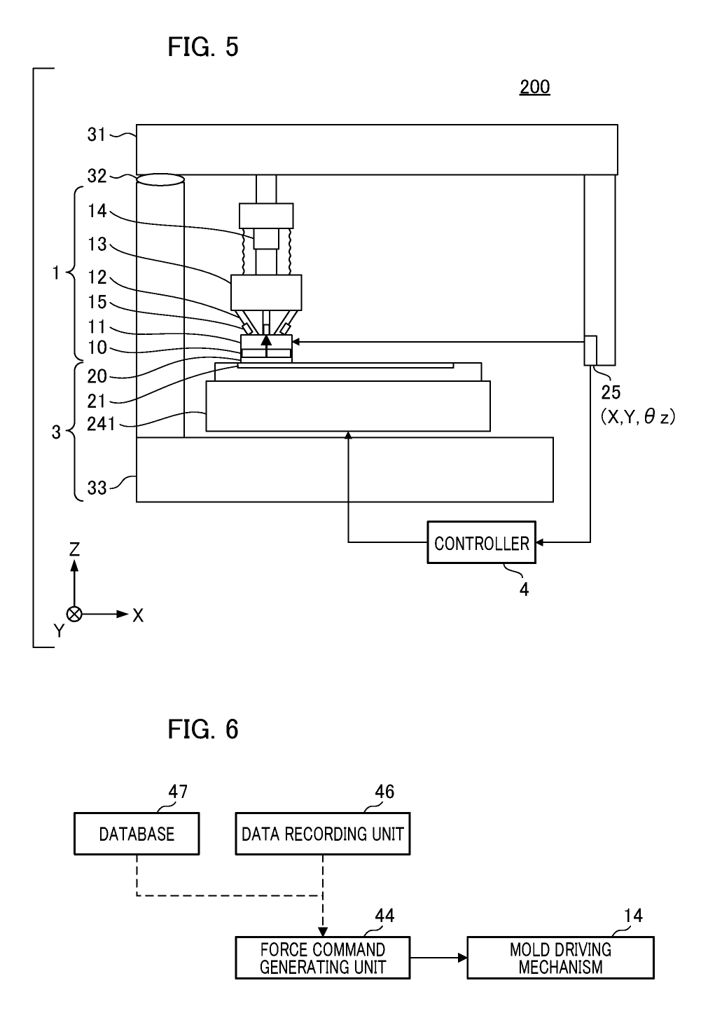

FIG. 5 is a schematic view illustrating a configuration of the imprint apparatus 200 according to the present embodiment. In the imprint apparatus 200, components corresponding to or similar to those in the imprint apparatus 100 according to the first embodiment are designated by the same reference numerals, and explanation thereof will be omitted. In the present embodiment, the mold driving mechanism 14 moves the mold 10 in the Z-axial direction so as to selectively bring the mold 10 into contact with the resin 20 on the substrate 21 or release the mold 10 from the resin 20. In contrast to the substrate stage 2 in the first embodiment, the substrate stage 3 included in the imprint apparatus 200 does not have the fine movement stage 22 but has an XY stage 241 which is similar to the coarse movement stage 24. In other words, the XY stage 241 is mounted on the surface plate 33, places the substrate 21, and moves in the XY-directions for positioning.

FIG. 6 is a block diagram illustrating an exemplary control system relating to the mold driving mechanism 14 included in the controller 4 in the present embodiment. Here, the substrate stage 3 does not have an actuator in the Z-axial direction, and thus, cannot send a force command in the Z-axial direction to the control system relating to the substrate stage 3. The mold-releasing force is generated by the mold driving mechanism 14. In this case, when the mold driving mechanism 14 starts application of the mold-releasing force, the force command generating unit 44 outputs a force command so as to gradually increase an upward force. Then, as in the above embodiments, the physical quantity for judging the timing of start of the mold-releasing is detected with use of the force sensor 15 or the like. After decision of the timing of start of the mold-releasing, the force command generating unit 44 calculates an upward force with reference to the database 47 and transmits it to the mold driving mechanism 14. The present embodiment also provides the same effect as that in the above embodiments.

### (Article Manufacturing Method)

A method of manufacturing article such as the aforementioned device (e.g., a microchip, a liquid crystal display) according to an embodiment of the present invention may include a step of forming a pattern on an object (e.g., wafer, glass plate, film substrate) using the aforementioned imprint apparatus. Furthermore, the article manufacturing method may include etching. When other articles such as a patterned medium (storage medium), an optical element, or the like are manufactured, the manufacturing method may include another step of processing the substrate on which a pattern has been formed instead of the etching step. The article manufacturing method of this embodiment has an advantage, as compared with a conventional article manufacturing method, in at least one of performance, quality, productivity and production cost of a device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-041491 filed on Mar. 3, 2015, which is hereby incorporated by reference herein in its entirety.

What is claimed is:

1. An imprint apparatus that brings a mold into contact with an imprint material on a substrate to perform patterning on the substrate, the imprint apparatus comprising:
a mold holder configured to hold the mold;
a substrate holder configured to hold the substrate;
a driving device configured to move at least one of the mold holder and the substrate holder;
a detector configured to detect a state of the driving device; and
a controller configured to perform decision that release of the mold is started based on an output of the detector and to control the driving device so as to decrease a force for the release by the driving device in accordance with the decision.

2. The imprint apparatus according to claim 1, wherein the controller is configured to output a command value for the driving device so as to increase the force for the release prior to the decision, and output a command value for the driving device so as to decrease the force for the release in accordance with the decision.

3. The imprint apparatus according to claim 2, wherein the detector is configured to detect, as the state, a force acting on at least one of the mold holder and the substrate holder.

4. The imprint apparatus according to claim 3, wherein the controller is configured to perform the decision based on a temporal change in the detected force.

5. The imprint apparatus according to claim 2, wherein the detector is configured to detect, as the state, a position of at least one of the mold holder and the substrate holder.

6. The imprint apparatus according to claim 5, wherein the controller is configured to perform the decision based on a deviation or a temporal change in the detected position.

7. An imprint method of bringing a mold into contact with an imprint material on a substrate to perform patterning, the method comprising steps of:
performing driving for moving at least one of the mold and the substrate;
detecting a state of the driving; and
performing decision that release of the mold is started based on the detecting,
wherein the driving is performed so as to decrease a force for the release by the driving in accordance with the decision.

8. A method of manufacturing an article, the method comprising steps of:
performing patterning on a substrate using an imprint apparatus; and
processing the substrate, on which the patterning has been performed, to manufacture the article,
wherein the imprint apparatus brings a mold into contact with an imprint material on the substrate to perform the patterning and includes:
a mold holder configured to hold the mold;
a substrate holder configured to hold the substrate;
a driving device configured to move at least one of the mold holder and the substrate holder;
a detector configured to detect a state of the driving device; and
a controller configured to perform decision that release of the mold is started based on an output of the detector and to control the driving device so as to decrease a force for the release by the driving device in accordance with the decision.

9. A method of manufacturing an article, the method comprising steps of:
performing patterning on a substrate using an imprint apparatus; and
processing the substrate, on which the patterning has been performed, to manufacture the article,
wherein the imprint method brings a mold into contact with an imprint material on the substrate to perform the patterning and includes steps of:
performing driving for moving at least one of the mold and the substrate;
detecting a state of the driving; and
performing decision that release of the mold is started based on the detecting,
wherein the driving is performed so as to decrease a force for the release by the driving in accordance with the decision.
